(19) United States
(12) Patent Application Publication
(10) Pub. No.: US 2026/0178939 A1
(43) Pub. Date: Jun. 25, 2026

(54) METHOD AND VIRTUAL AGENT SYSTEM FOR GENERATING NEAR REAL-TIME RESPONSES TO USER QUERIES

(71) Applicant: HCL Technologies Limited, New Delhi (IN)

(72) Inventors: Akshay Ashokkumar Jha, Noida (IN); Ajay Singh, Noida (IN); Mrinal Singh, Noida (IN); Saurabh Mangla, Noida (IN)

(21) Appl. No.: 19/095,087

(22) Filed: Mar. 31, 2025

(30) Foreign Application Priority Data
Dec. 23, 2024 (IN) 202411102218

(51) Int. Cl. G06N 5/04; G06F 40/30

(52) U.S. Cl. CPC G06N 5/04; G06F 40/30

(57) ABSTRACT

This disclosure relates to method and system for generating near real-time responses to user queries. The method may include generating, via a Large Language Model (LLM), a set of predicted queries and a corresponding set of predicted responses, based on historical data or a real-time input user query associated with a user account, using a customized knowledge graph; creating a set of predicted query embeddings and a set of predicted response embeddings, using an embedding model; comparing a subsequently received real-time input user query with each of the set of predicted queries through a similarity analysis; and upon successful comparison of at least one of the set of predicted queries, generating in near real-time, via the LLM, a response to the real-time input user query based on the set of predicted response embeddings of each of corresponding predicted responses using the customized knowledge graph.

### TECHNICAL FIELD

This disclosure generally relates to intelligent virtual agent systems, and more particularly to a method and virtual agent system for generating near real-time responses to user queries.

### BACKGROUND

Many companies make use of virtual agents to communicate with customers without needing a human representative. Typically, the virtual agents are deployed as chatbots. Recent advancements in conversational Artificial Intelligence (AI), speech-to-text algorithms, and sentiment analysis, allow conventional virtual agents to interpret open-ended customer queries and accurately identify an intent of the customer.

However, in the present state of art, virtual agents may take a significant amount of time to address or comprehend customer queries. This limitation arises because conventional virtual agents are configured to identify and respond to a predefined set of questions. However, in a real world scenario, a customer may phrase a query which may not be in accordance with the predefined set of questions. Thus, the conventional virtual agents may fail to address more complex or unique customer queries.

Additionally, the conventional virtual agents may fail to address a language barrier with the customer. Many existing virtual agents do not support multiple languages, which may limit accessibility for non-English speakers. This restriction may hinder effective customer service and may negatively impact a user experience of the customers.

Therefore, there is a requirement for a more diverse and automated virtual agents for a smooth functioning for customer query resolutions.

### SUMMARY

In one embodiment, a method for generating near real-time responses to user queries is disclosed. In one example, the method may include initiating a user session associated with a user account. The method may further include generating, via a Large Language Model (LLM), a set of predicted queries and a corresponding set of predicted responses, based on historical data or a real-time input user query associated with the user account, using a customized knowledge graph. The customized knowledge graph may be based on domain-specific data and enterprise-specific data. The method may further include creating a set of predicted query embeddings from each of the set of predicted queries and a set of predicted response embeddings from each of the set of predicted responses, using an embedding model. The method may further include comparing a subsequently received real-time input user query with each of the set of predicted queries through a similarity analysis. The comparing may include creating a set of input user query embeddings from the real-time input user query using the embedding model. The comparing may further include calculating a semantic similarity score between the set of input user query embeddings and the set of predicted user query embeddings of each the set of predicted user queries. The comparing may further include comparing the semantic similarity score with a predefined threshold semantic similarity score. Upon successful comparison of at least one of the set of predicted queries, the method may further include generating in near real-time, via the LLM, a response to the real-time input user query based on the set of predicted response embeddings of each of at least one of the set of predicted responses corresponding to each of the at least one of the set of predicted queries using the customized knowledge graph.

In one embodiment, a system for generating near real-time responses to user queries is disclosed. In one example, the system may include a processor and a memory communicatively coupled to the processor. The memory may store processor-executable instructions, which, on execution, may cause the processor to initiate a user session associated with a user account. The processor-executable instructions, on execution, may further cause the processor to generate, via an LLM, a set of predicted queries and a corresponding set of predicted responses, based on historical data or a real-time input user query associated with the user account, using a customized knowledge graph. The customized knowledge graph may be based on domain-specific data and enterprise-specific data. The processor-executable instructions, on execution, may further cause the processor to create a set of predicted query embeddings from each of the set of predicted queries and a set of predicted response embeddings from each of the set of predicted responses, using an embedding model. The processor-executable instructions, on execution, may further cause the processor to compare a subsequently received real-time input user query with each of the set of predicted queries through a similarity analysis. To compare, the processor-executable instructions, on execution, may cause the processor to create a set of input user query embeddings from the real-time input user query using the embedding model, calculate a semantic similarity score between the set of input user query embeddings and the set of predicted user query embeddings of each the set of predicted user queries, and compare the semantic similarity score with a predefined threshold semantic similarity score. Upon successful comparison of at least one of the set of predicted queries, the processor-executable instructions, on execution, may further cause the processor to generate in near real-time, via the LLM, a response to the real-time input user query based on the set of predicted response embeddings of each of at least one of the set of predicted responses corresponding to each of the at least one of the set of predicted queries using the customized knowledge graph.

In one embodiment, a non-transitory computer-readable medium storing computer-executable instructions for generating near real-time responses to user queries is disclosed. In one example, the stored instructions, when executed by a processor, may cause the processor to perform operations including initiating a user session associated with a user account. The operations may further include generating, via an LLM, a set of predicted queries and a corresponding set of predicted responses, based on historical data or a real-time input user query associated with the user account, using a customized knowledge graph. The customized knowledge graph may be based on domain-specific data and enterprise-specific data. The operations may further include creating a set of predicted query embeddings from each of the set of predicted queries and a set of predicted response embeddings from each of the set of predicted responses, using an embedding model. The operations may further include comparing a subsequently received real-time input user query with each of the set of predicted queries through a similarity analysis. For comparing, the operations may include creating a set of input user query embeddings from the real-time input user query using the embedding model, calculating a semantic similarity score between the set of input user query embeddings and the set of predicted user query embeddings of each the set of predicted user queries, and comparing the semantic similarity score with a predefined threshold semantic similarity score. Upon successful comparison of at least one of the set of predicted queries, the operations may further include generating in near real-time, by the processor via the LLM, a response to the real-time input user query based on the set of predicted response embeddings of each of at least one of the set of predicted responses corresponding to each of the at least one of the set of predicted queries using the customized knowledge graph.

It is to be understood that both the foregoing general description and the following detailed description are exemplary and explanatory only and are not restrictive of the invention, as claimed.

### BRIEF DESCRIPTION OF THE DRAWING

The accompanying drawings, which are incorporated in and constitute a part of this disclosure, illustrate exemplary embodiments and, together with the description, serve to explain the disclosed principles.

FIG. 1 illustrates a block diagram of an exemplary virtual agent system for generating near real-time responses to user queries, in accordance with some embodiments of the present disclosure.

FIG. 2 illustrates a functional block diagram of a virtual agent system for generating near real-time responses to user queries, in accordance with some embodiments of the present disclosure.

FIG. 3A and FIG. 3B illustrate a flow diagram of an exemplary process for generating near real-time responses to user queries, in accordance with some embodiments of the present disclosure.

FIG. 4 illustrates a flowchart of an exemplary process for generating a set of predicted queries and a corresponding set of predicted responses, in accordance with some embodiments of the present disclosure.

FIG. 5 illustrates a flowchart of an exemplary process for generating in near real-time, a response to the real-time input user query, in accordance with some embodiments of the present disclosure.

FIG. 6 is a block diagram of an exemplary computer system for implementing embodiments consistent with the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed.

Further, the phrases “in some embodiments”, “in accordance with some embodiments”, “in the embodiments shown”, “in other embodiments”, and the like, mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope and spirit being indicated by the following claims.

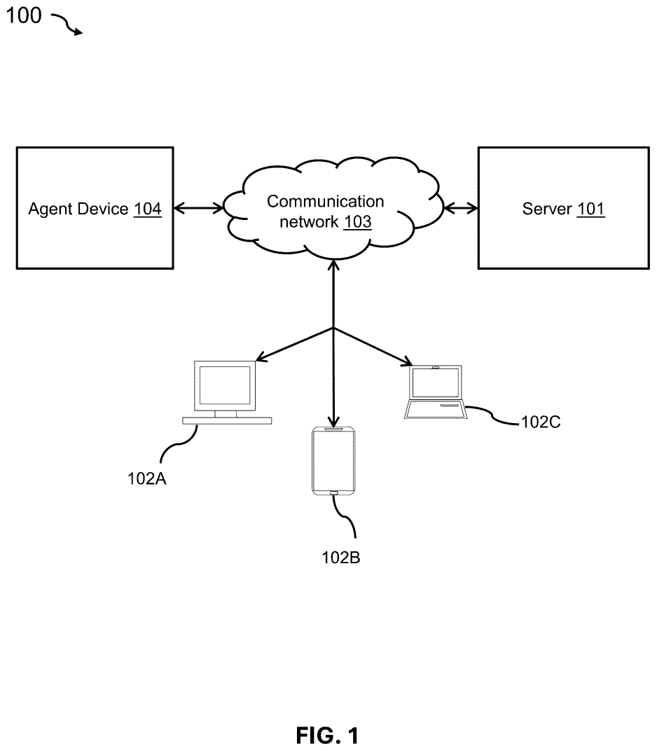

Referring now to FIG. 1, a block diagram of an exemplary virtual agent system 100 for generating near real-time responses to user queries is illustrated, in accordance with some embodiments of the present disclosure. The virtual agent system 100 may include a server 101 and a plurality of user devices (for example, a user device 102A, a user device 102B, and a user device 102C) communicably connected to each other through a communication network 103. Each of the plurality of user devices may be a mobile phone, a telephone, a smartphone, a laptop, a desktop, a tablet, or any other electronic device with a communication capability. The server 101 may host a virtual agent that may communicate with a plurality of users (for example, customers) operating the plurality of user devices, through the communication network 103. Examples of the communication network 103 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and a combination thereof.

Each of the plurality of users may conduct conversations with the virtual agent (via the server 101) in a form of telephonic calls, Voice over Internet Protocol (VoIP) communication, e-mails, text messaging, WebRTC communication, or any other real-time or non-real time communication. The VoIP communication may be controlled by a signalling protocol over the Internet, such as, Session Initiation Protocol (SIP), H.323, or the like.

The server 101 and the hosted virtual agent may be associated with an enterprise. In an embodiment, the plurality of user devices may access the virtual agent from the server 101 through an application of the enterprise. In such an embodiment, the virtual agent may be integrated with the application to interact with the users of the application to assist the users in various ways, such as resolving issues, guiding the users for performing different actions, providing information related to different features of the application, or the like.

Each of the plurality of users may be registered to use the application through a user account. The user account may include the authentication information (e.g., login credentials, One Time Password (OTP), Multi-Factor Authentication (MFA), or the like) and historical data (e.g., application usage history, transaction history, purchase history, previous interactions with the virtual agent, etc.) of the user. Additionally, the user account may include a set of profile parameters of the user (such as name, date of birth, age, gender, mobile number, email address, user preferences corresponding to one or more features of the application (e.g., preferred language, application theme, mode of payment, etc.), and the like). When a user runs the application from a user device, the user may be prompted to enter the authentication information to log in to the registered user account (if not already logged in).

In an alternative embodiment, the plurality of user devices may communicate directly with the virtual agent through the communication network 103 (for example, by directly contacting the virtual agent through a predefined contact number (e.g., phone number) or a predefined contact ID (e.g., a video call application address (such as Skype address), etc.)). By way of an example, such an embodiment may be implemented to use the virtual agent to facilitate operations in a contact center. In such an embodiment, the user account may be associated with a contact number of the user. Thus, the authentication information may be the contact number of the user. The historical data may include, but may not be limited to, call history, transcripts of previous calls, feedback provided on helpfulness of the previous calls, and the like.

Further, the server 101 may initiate a user session associated with the user account. In some embodiments, the user session may be automatically initiated once the user logs into the application. Alternatively, the user session may be initiated once the user accesses certain features of the application (for example, when the user may initiate a chat or a telephonic conversation with the virtual agent). Further, the user may provide a real-time input user query via a user device (for example, the user device 102A). The real-time input user query may be in an audio format (via voice call, audio recording, or video call) or a text format (via chat). If the real-time input user query is in the audio format, the server 101 may transform the real-time input user query to the text format through a speech-to-text-conversion technique.

Further, the server 101 may generate, via a Large Language Model (LLM), a set of predicted queries and a corresponding set of predicted responses, based on at least one of the historical data or the real-time input user query associated with the user account, using a customized knowledge graph. Examples of the LLM may include, but are not limited to, zephyr, Large Language Model Meta AI (LLAMA), Generative Pre-trained Transformer (GPT), Gemini, Falcon LLM, BLOOM, etc.

The customized knowledge graph may enhance the LLM by providing external knowledge (i.e., knowledge based on the domain-specific data and the enterprise-specific data) for inference and interpretability. The customized knowledge graph may be based on domain-specific data (i.e., data related to domain of the enterprise) and enterprise-specific data (i.e., data related to the enterprise). By way of an example, for a banking enterprise, the domain-specific data may include data related to banking and finance (such as regulatory banking laws in the country of the user, general banking and finance-related concepts, etc.), and the enterprise-specific data may include data particular to the banking enterprise (such as user account information, enterprise deals and offers, enterprise policy, etc.).

In an embodiment, the server 101 may predict, via the LLM, the set of predicted queries using the historical data associated with the user account prior to receiving the real-time input user query. In such an embodiment, each of the set of predicted queries may be a complete query. In other words, the server 101 may predict complete queries corresponding to the real-time input user query based on the historical data. The historical data may include interaction history (i.e., chat/conversation history) of the user (of previous user sessions as well as the current user session) with the virtual agent. Additionally, the historical data may include other data previously stated as examples for the historical data.

In another embodiment, the server 101 may predict in real-time, via the LLM, a set of second portions of the real-time input user query based on a first portion of the real-time input user query received in real-time. In such an embodiment, each of the set of second portions may correspond to a predicted remaining portion of the first portion. In other words, given a first set of words of the real-time input user query provided by the user, the server 101 may predict next words of the real-time input user query. It should be noted that server 101 may also use the historical data of the user to predict the set of second portions of the real-time input user query. Further, the server 101 may combine, via the LLM, the first portion of the real-time input user query with each of the predicted set of second portions to obtain the set of predicted queries. Thus, the set of predicted queries obtained in such an embodiment includes partially predicted queries based on a portion of the real-time input user query provided by the user.

Additionally, the server 101 may also generate, via the LLM, a set of predicted responses corresponding to the set of predicted queries using the customized knowledge graph. This may ensure that the server 101 is prepared with a set of predicted responses in case the real-time input user query matches with (or is similar to) one of the set of predicted queries. In other words, the server 101 may implement an anti-delay intelligence-based system.

Further, the server 101 may create a set of predicted query embeddings from each of the set of predicted queries and a set of predicted response embeddings from each of the set of predicted responses, using an embedding model (such as Word2Vec, Continuous Bag of Words (CBOW), Skip-Gram model, GloVe, Fasttext, etc.). In an embodiment, the server 101 may store the set of predicted query embeddings and the set of predicted response embeddings in a vector database (or a Retrieval Augmented Generation (RAG) model). Further, once the user provides the real-time input user query, the server 101 may retrieve the set of predicted query embeddings from the vector database.

Further, the server 101 may compare a subsequently received real-time input user query with each of the set of predicted queries through a similarity analysis. The similarity analysis may be based on a similarity score, such as a semantic similarity score. For comparison, the server 101 may create a set of input user query embeddings from the real-time input user query using the embedding model. Further, the server 101 may calculate the semantic similarity score between the set of input user query embeddings and the set of predicted user query embeddings of each the set of predicted user queries. Further, the server 101 may compare the semantic similarity score with a predefined threshold semantic similarity score.

Upon successful comparison of at least one of the set of predicted queries, the server 101 may generate in near real-time, via the LLM, a response to the real-time input user query based on the set of predicted response embeddings of each of at least one of the set of predicted responses corresponding to each of the at least one of the set of predicted queries using the customized knowledge graph. The prediction of possible queries for the real-time input user query and generation of the responses to the possible queries in advance enables the server 101 to generate response to the real-time input user query in near real-time. This enhances the user experience of the user, making the interaction more natural (i.e., human-like).

In some embodiments, the server 101 may also determine a context and a user intent based on the real-time input user query and the historical data using a Natural Language Processing (NLP) model. In such embodiments, the server 101 may also use the context and the user intent to generate the response to the real-time input user query.

In case the comparison fails for each of the set of predicted queries, the server 101 may generate, via the LLM, a response to the real-time input user query using the customized knowledge graph. The response in this scenario may be processed at a regular processing speed.

The response generated by the LLM to the real-time input user query may be in a text format. In case the user is interacting with the virtual agent through a voice interaction, the server 101 may transform the format of the response to an audio format using a text-to-speech conversion algorithm to generate an audio output response to the real-time input user query. The near real-time response of the server 101 to the user query may make the conversation seem more natural to the user, enhancing the user experience.

In some embodiments, a live agent may monitor the real-time interaction between the user and the virtual agent through an agent device 104. The agent device 104 may be communicatively coupled to the server 101 through the communication network 103. In case the server 101 may fail to resolve the queries provided by the user, server 101 may route the communication with the user device 102A to the agent device 104. This may allow the live agent to intercept and resolve the user queries.

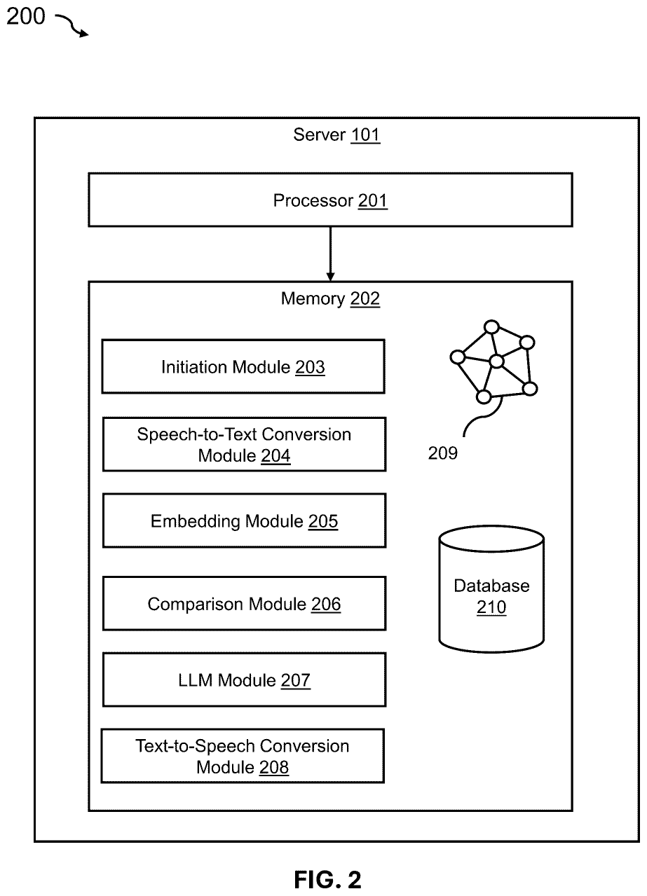

Referring now to FIG. 2, a functional block diagram of a virtual agent system 200 for generating near real-time responses to user queries is illustrated, in accordance with an embodiment of the present disclosure. FIG. 2 is explained in conjunction with FIG. 1. The server 101 may include a processor 201 and a memory 202. Examples of processor(s) 201 may include but are not limited to, an Intel® Itanium® or Itanium 2 processor(s), or AMD® Opteron® or Athlon MP® processor(s), Motorola® lines of processors, Nvidia®, FortiSOC™ system on a chip processors or other future processors. The memory 202 may store instructions that, when executed by the processor 201, may cause the processor 201 to generate near real-time responses to user queries. In an embodiment, the memory 204 may include but may not be limited to, a flash memory, a Read Only Memory (ROM), a Programmable ROM (PROM), Erasable PROM (EPROM), and Electrically EPROM (EEPROM) memory. Further, examples of volatile memory may include but are not limited to, Dynamic Random Access Memory (DRAM), and Static Random-Access memory (SRAM).

The memory 202 may include an initiation module 203, a speech-to-text conversion module 204, an embedding module 205, a comparison module 206, an LLM module 207, a text-to-speech conversion module 208, a customized knowledge graph 209, and a database 210.

The initiation module 203 may initiate a user session associated with a user account. In an embodiment, the user account may include authentication information and historical data of the user. The initiation module 203 may receive a real-time input user query from a user device (such as the user device 102A) in a format selected from a text format or an audio format. When the format is the audio format, the initiation module 203 may send the real-time input user query to the speech-to-text conversion module 204. Further, the speech-to-text conversion module 204 may transform the format of the real-time input user query into the text format using a speech-to-text conversion technique prior to comparing with each of the set of predicted queries.

Once the real-time input user query is obtained in the text format (either directly or through the speech-to-text conversion module 204), the LLM module 207 may generate, via an LLM, a set of predicted queries and a corresponding set of predicted responses, based on at least one of historical data or a real-time input user query associated with the user account, using the customized knowledge graph 209. It may be noted that the customized knowledge graph 209 may be based on domain-specific data and enterprise-specific data.

The customized knowledge graph 209 may be continuously updated with relationships including information on products, services, FAQs, and troubleshooting steps. The customized knowledge graph 209 may be a relation oriented knowledge base, facilitating more accurate, context-aware, and efficient responses by the LLM, leading to improved customer satisfaction and operational efficiency. The structured and semantically rich framework provided by the ontology enhances every aspect of performance, from data organization and retrieval to machine learning and NLP capabilities.

The customized knowledge graph 209 and the database 210 may constitute a dynamic repository that updates automatically with new information, ensuring the most current data is always available. This may enable the responses and knowledge base entries to be tailored (or customized) to specific industries and business needs, providing highly relevant and accurate support.

The LLM module 207 may use the customized knowledge graph 209, previous interactions, and historical data to provide context-aware responses. The LLM may be configured (or fine-tuned) to employ natural and conversational language to enhance user experience by mimicking human tonality. In some embodiments, conversational language models may be employed that mimic human interaction styles, enhancing user experience and satisfaction. Additionally, the LLM continuously learns from new interactions, feedback, and resolved queries to improve response accuracy and relevance using deep learning and reinforcement learning techniques. The LLM may also incorporate user feedback to refine and optimize performance.

In an embodiment, to generate the set of predicted queries and the corresponding set of predicted responses, the LLM module 207 may predict, via the LLM, the set of predicted queries using the historical data associated with the user account prior to receiving the real-time input user query. In such an embodiment, each of the set of predicted queries is a complete query.

In an alternative embodiment, to generate the set of predicted queries and the corresponding set of predicted responses, the LLM module 207 may predict in real-time, via the LLM, a set of second portions of the real-time input user query based on a first portion of the real-time input user query received in real-time. In such an embodiment, each of the set of second portions corresponds to a predicted remaining portion of the first portion. Further, the LLM module 207 may combine, via the LLM, the first portion with each of the predicted set of second portions to obtain the set of predicted queries.

Further, the embedding module 205 may create a set of predicted query embeddings from each of the set of predicted queries and a set of predicted response embeddings from each of the set of predicted responses, using an embedding model. Further, the embedding module 205 may store the set of predicted query embeddings and the set of predicted response embeddings in the database 210. The database 210 may be a vector database.

Further, the initiation module 203 may receive the real-time input user query. Thus, the LLM module 207 may generate the set of predict user queries prior to receiving the real-time input user query. In simpler words, the LLM module 207 is predicting what the user query could be. In some embodiments, the initiation module 203 may determine a context and a user intent based on the real-time input user query and the historical data using an NLP model. The initiation module 203, via the NLP model, may extract relevant entities from the real-time input user query to understand the context and specifics of the real-time input user query.

The initiation module 203, via the NLP model, may employ sophisticated NLP techniques to understand the deeper context of queries, enabling more accurate and relevant responses. Additionally, the initiation module 203 may retain context throughout the conversation by storing relevant information in the database 210, providing continuity and a more human-like interaction experience.

Upon receiving the real-time input user query, the comparison module 206 may retrieve the set of predicted query embeddings from the database 210. Further, the embedding module 205 and the comparison module 206 may compare a subsequently received real-time input user query with each of the set of predicted queries through a similarity analysis.

To perform the comparison, the embedding module 205 may create a set of input user query embeddings from the real-time input user query using the embedding model. Further, the comparison module 206 may calculate a semantic similarity score between the set of input user query embeddings and the set of predicted user query embeddings of each the set of predicted user queries. Further, the comparison module 206 may compare the semantic similarity score with a predefined threshold semantic similarity score.

Upon successful comparison of at least one of the set of predicted queries, the LLM module 207 may generate in near real-time, via the LLM, a response to the real-time input user query based on the set of predicted response embeddings of each of at least one of the set of predicted responses corresponding to each of the at least one of the set of predicted queries using the customized knowledge graph 209.

To generate the near real-time response, the embedding module 205 may retrieve the set of predicted response embeddings of a predicted response corresponding to the successfully compared predicted query. Further, the embedding module 205 may provide a response generation prompt to the LLM module 207. The response generation prompt comprises the real-time input user query and the set of predicted response embeddings of each of the at least one of the set of predicted responses.

Upon unsuccessful comparison of each of the set of predicted queries, the LLM module 207 may generate, via the LLM, a response to the real-time input user query using the customized knowledge graph 209.

Further, the LLM module 207 may send the near real-time response or the response (referred interchangeably as the response to the real-time input user query) to the text-to-speech conversion module 208. The text-to-speech conversion module 208 may transform a format of the response to the real-time input user query to an audio format using a text-to-speech conversion algorithm to generate an audio output response to the real-time input user query.

The LLM may continuously learn from each interaction, integrating new data in real-time to improve its performance, reducing the need for manual updates or periodic retraining. In some embodiments, hybrid response generation may be implemented to include a combination of rule-based approach and generative AI for response generation. the precision of rule-based systems with the flexibility and creativity of generative models to deliver high-quality responses. This hybrid approach ensures both accuracy and the ability to handle unexpected queries.

In case the user is not satisfied with the response, a live agent monitoring the interaction may intercept and may address the user queries. In other words, the LLM module 207 may identify and direct complex or unresolved queries to human agents using the LLM. Additionally, the LLM module 207 may also provide the human agents with context and conversation history to facilitate quicker resolution. This also prevents any misinformation or misguidance being provided by a solely LLM-based response generation.

In some embodiments, the LLM module 207 may manage call queues using the LLM based on priority, urgency, and customer profile. The LLM module 207 may also track key performance indicators (KPIs) such as response time, resolution rate, and customer satisfaction. Additionally, the LLM module 207 may provide detailed reports and analytics to identify trends, common issues, and areas for improvement.

It should be noted that all such aforementioned modules 203-208 may be represented as a single module or a combination of different modules. Further, as will be appreciated by those skilled in the art, each of the modules 203-208 may reside, in whole or in parts, on one device or multiple devices in communication with each other. In some embodiments, each of the modules 203-208 may be implemented as dedicated hardware circuit comprising custom application-specific integrated circuit (ASIC) or gate arrays, off-the-shelf semiconductors such as logic chips, transistors, or other discrete components. Each of the modules 203-208 may also be implemented in a programmable hardware device such as a field programmable gate array (FPGA), programmable array logic, programmable logic device, and so forth. Alternatively, each of the modules 203-208 may be implemented in software for execution by various types of processors (e.g., processor 201). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for generating near real-time responses to user queries. For example, the exemplary system 100 and the associated server 101 may generate near real-time responses by the processes discussed herein. In particular, as will be appreciated by those of ordinary skill in the art, control logic and/or automated routines for performing the techniques and steps described herein may be implemented by the system 100 and the associated server 101 either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

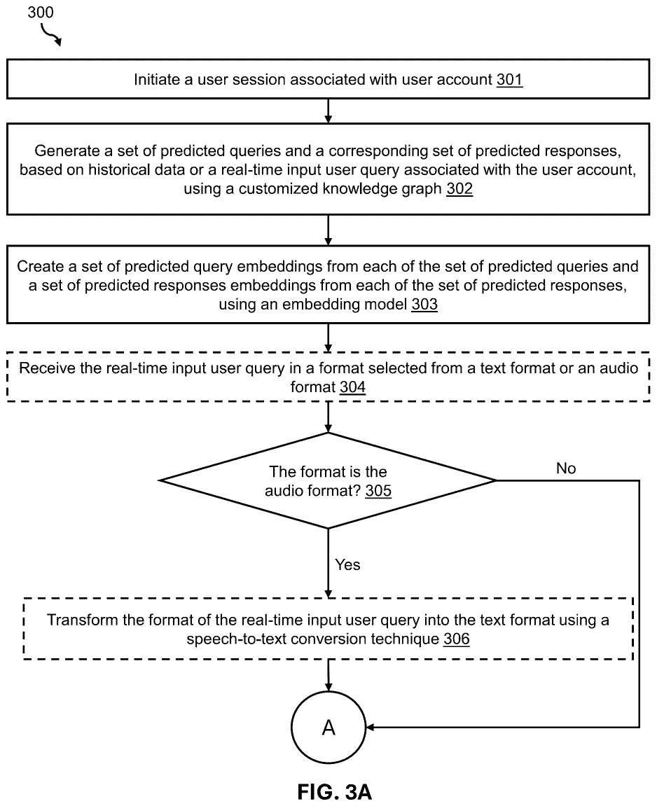

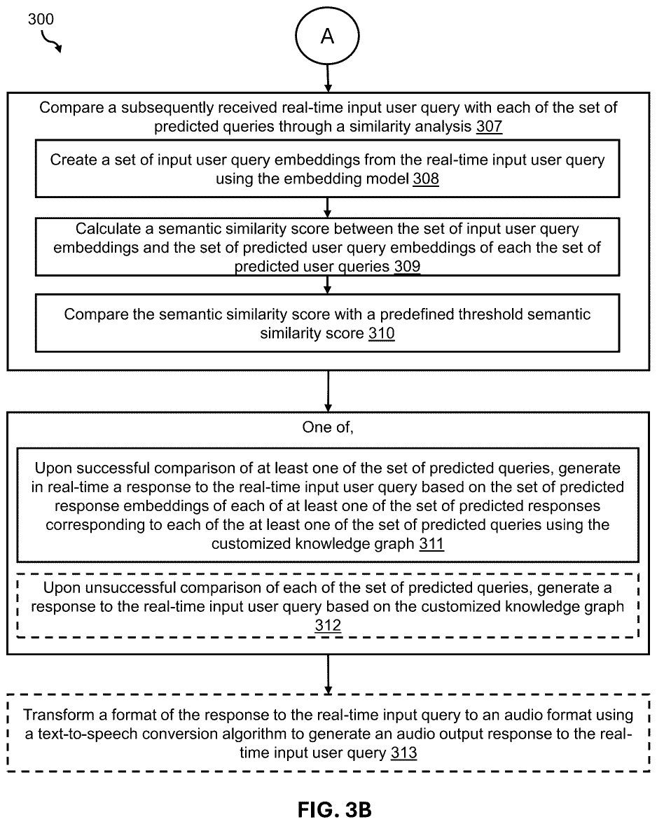

Referring to FIG. 3A and FIG. 3B, an exemplary process 300 for generating near real-time responses to user queries is depicted via a flow chart, in accordance with some embodiments of the present disclosure. FIG. 3A and FIG. 3B are explained in conjunction with FIGS. 1 and 2. The process 300 may be implemented by the server 101. At step 301 of the process 300, the initiation module 203 may initiate the user session associated with the user account via the LLM.

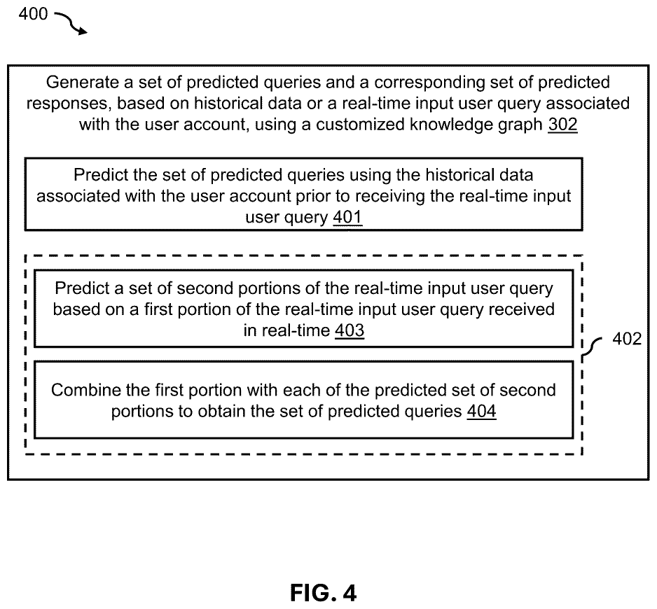

At step 302 of the process 300, the LLM module 207 may generate, via the LLM, the set of predicted queries and simultaneously generate the set of predicted responses corresponding to the set of the predicted queries, based on at least one of historical data or a real-time input query associated with the user account, using the ontology-backed customized knowledge graph 209. In an embodiment, the customized knowledge graph 209 may be based on the domain-specific data and the enterprise-specific data. This is discussed in greater detail in conjunction with FIG. 4.

At step 303, the embedding module 205 may create a set of predicted query embeddings from each of the set of predicted queries and a set of predicted response embeddings from each of the set of predicted responses, using an embedding model. The embedding module 205 may store the set of predicted query embeddings and the set of predicted response embeddings in a vector database (such as the database 210).

At step 304, the initiation module 203 may receive the real-time input user query in a format selected from a text format or an audio format. At step 305, the initiation module 203 may perform a check to determine whether the format is the audio format. If the format is the audio format (“Yes” path), at step 306, the speech-to-text conversion module 204 may transform the format of the real-time input user query into the text format using a speech-to-text conversion technique. Further, the process 300 may proceed to step 307. If the format is not the audio format (“No” path), the process 300 may proceed to step 307. In some embodiments, the initiation module 203 may determine a context and a user intent based on the real-time input user query and the historical data using an NLP model.

At step 307, the embedding module 205 and the comparison module 206 may compare a subsequently received real-time input user query with each of the set of predicted queries through a similarity analysis. It should be noted that the term “subsequently received real-time input user query” implies herein that the real-time input user query is received subsequent to the generation of the set of predicted queries and the corresponding set of predicted responses. In other words, the set of predicted queries and the corresponding set of predicted responses are generated prior to receiving the actual user query (i.e., the real-time input user query).

The step 307 may include steps 308, 309, and 310. At step 308, the embedding module 205 may create a set of input user query embeddings from the real-time input user query using the embedding model. At step 309, the comparison module 206 may calculate a semantic similarity score between the set of input user query embeddings and the set of predicted user query embeddings of each the set of predicted user queries. At step 310, the comparison module 206 may compare the semantic similarity score with a predefined threshold semantic similarity score.

Thereafter, upon successful comparison of at least one of the set of predicted queries at the step 307, the process 300 may proceed to step 311. At step 311, the LLM module 207 may generate in near real-time, via the LLM, a response to the real-time input user query based on the set of predicted response embeddings of each of at least one of the set of predicted responses corresponding to each of the at least one of the set of predicted queries using the customized knowledge graph.

Upon unsuccessful comparison of each of the set of predicted queries at step 307, the process 300 may proceed to the step 312. At step 312, the LLM module 207 may generate, via the LLM, a response to the real-time input user query using the customized knowledge graph. In other words, when none of the set of predicted queries is optimally matches with the real-time input user query, the LLM module 207 may generate the response to the user query directly via the LLM. That is to say, none of the set of predicted responses may be used in this case.

At step 313, once the response to the real-time input user query is generated, the text-to speech conversion module 208 may transform a format of the response to the real-time input user query to an audio format using a text-to-speech conversion algorithm to generate an audio output response to the real-time input user query.

Referring now to FIG. 4, an exemplary process 400 for generating predicted queries and corresponding predicted responses, in accordance with an embodiment of the present disclosure is illustrated. FIG. 4 is explained in conjunction with FIGS. 1, 2, and 3. The process 400 may be implemented by the server 101. At step 302, the LLM module 207 generate, via an LLM, a set of predicted queries and a corresponding set of predicted responses, based on at least one of historical data or a real-time input user query associated with the user account, using a customized knowledge graph. The customized knowledge graph is based on domain-specific data and enterprise-specific data.

The step 302 may include steps 401 and 402. The step 302 may be implemented by one or both of the steps 401 and 402. In other words, the step 302 may be implemented through various embodiments via the step 401, the step 402, or a combination thereof. At step 401, the LLM module 207 may predict, via the LLM, the set of predicted queries using the historical data associated with the user account prior to receiving the real-time input user query. In such an embodiment, each of the set of predicted queries is a complete query.

The step 402 may include steps 403 and 404. At the step 403, the LLM module 207 may predict in real-time, via the LLM, a set of second portions of the real-time input user query based on a first portion of the real-time input user query received in real-time. Each of the set of second portions corresponds to a predicted remaining portion of the first portion. At the step 404, the LLM module 207 may combine, via the LLM, the first portion with each of the predicted set of second portions to obtain the set of predicted queries.

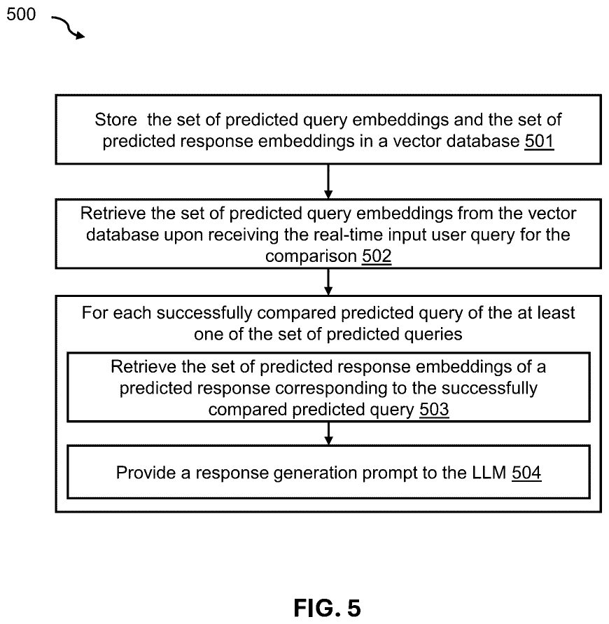

Referring now to FIG. 5, an exemplary process 500 for generating responses to real-time input user queries is depicted via a flow chart, in accordance with some embodiments of the present disclosure. FIG. 5 is explained in conjunction with FIGS. 1, 2, and 3. The process 500 may be implemented by the server 101. At step 501, the embedding module 205 may store the set of predicted query embeddings and the set of predicted response embeddings in a vector database (such as the database 210).

At step 502, the comparison module 206 may retrieve the set of predicted query embeddings from the vector database upon receiving the real-time input user query for the comparison.

At step 503, for each successfully compared predicted query of the at least one of the set of predicted queries, the LLM module 207 may retrieve the set of predicted response embeddings of a predicted response corresponding to the successfully compared predicted query. At step 504, for each successfully compared predicted query of the at least one of the set of predicted queries, the LLM module 207 may provide a response generation prompt to the LLM. The response generation prompt may include the real-time input user query and the set of predicted response embeddings of each of the at least one of the set of predicted responses. Thereafter, the LLM module 207 may generate a response to the real-time input user query in response to the response generation prompt.

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

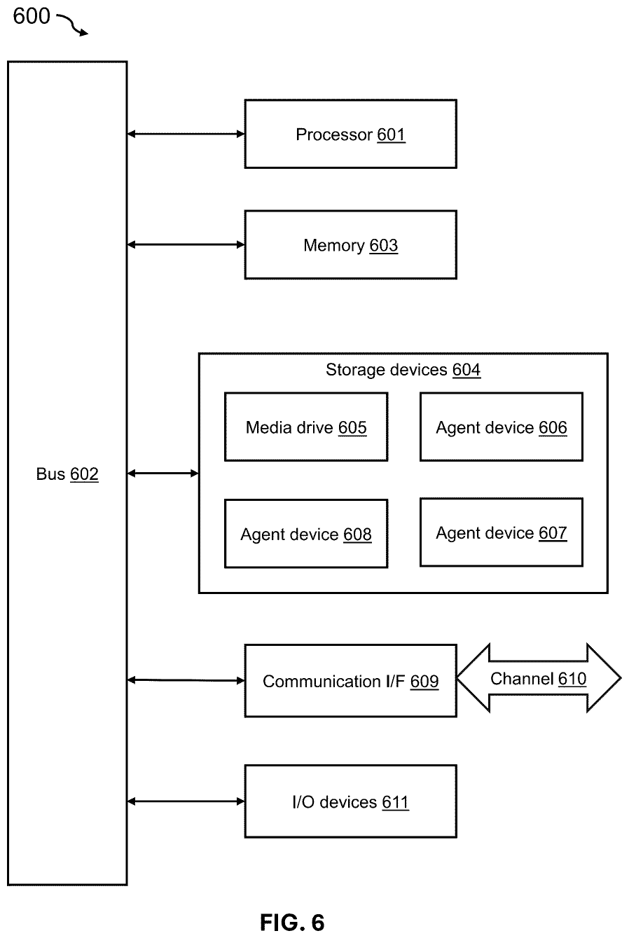

The disclosed methods and systems may be implemented on a conventional or a general-purpose computer system, such as a personal computer (PC) or server computer. Referring now to FIG. 6, an exemplary computing system 600 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 600 may represent, for example, a user device such as a desktop, a laptop, a mobile phone, personal entertainment device, DVR, and so on, or any other type of special or general-purpose computing device as may be desirable or appropriate for a given application or environment. The computing system 600 may include one or more processors, such as a processor 601 that may be implemented using a general or special purpose processing engine such as, for example, a microprocessor, microcontroller or other control logic. In this example, the processor 601 is connected to a bus 602 or other communication medium. In some embodiments, the processor 601 may be an Artificial Intelligence (AI) processor, which may be implemented as a Tensor Processing Unit (TPU), or a graphical processor unit, or a custom programmable solution Field-Programmable Gate Array (FPGA).

The computing system 600 may also include a memory 603 (main memory), for example, Random Access Memory (RAM) or other dynamic memory, for storing information and instructions to be executed by the processor 601. The memory 603 also may be used for storing temporary variables or other intermediate information during execution of instructions to be executed by the processor 601. The computing system 600 may likewise include a read only memory (“ROM”) or other static storage device coupled to bus 602 for storing static information and instructions for the processor 601.

The computing system 600 may also include a storage device 604, which may include, for example, a media drives 605 and a removable storage interface. The media drive 605 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 606 may include, for example, a hard disk, magnetic tape, flash drive, or other fixed or removable medium that is read by and written to by the media drive 605. As these examples illustrate, the storage media 606 may include a computer-readable storage medium having stored there in particular computer software or data.

In alternative embodiments, the storage devices 604 may include other similar instrumentalities for allowing computer programs or other instructions or data to be loaded into the computing system 600. Such instrumentalities may include, for example, a removable storage unit 607 and a storage unit interface 608, such as a program cartridge and cartridge interface, a removable memory (for example, a flash memory or other removable memory module) and memory slot, and other removable storage units and interfaces that allow software and data to be transferred from the removable storage unit 607 to the computing system 600.

The computing system 600 may also include a communications interface 609. The communications interface 609 may be used to allow software and data to be transferred between the computing system 600 and external devices. Examples of the communications interface 609 may include a network interface (such as an Ethernet or other NIC card), a communications port (such as for example, a USB port, a micro USB port), Near field Communication (NFC), etc. Software and data transferred via the communications interface 609 are in the form of signals which may be electronic, electromagnetic, optical, or other signals capable of being received by the communications interface 609. These signals are provided to the communications interface 609 via a channel 610. The channel 610 may carry signals and may be implemented using a wireless medium, wire or cable, fiber optics, or other communications medium. Some examples of the channel 610 may include a phone line, a cellular phone link, an RF link, a Bluetooth link, a network interface, a local or wide area network, and other communications channels.

The computing system 600 may further include Input/Output (I/O) devices 611. Examples may include, but are not limited to a display, keypad, microphone, audio speakers, vibrating motor, LED lights, etc. The I/O devices 611 may receive input from a user and also display an output of the computation performed by the processor 601. In this document, the terms “computer program product” and “computer-readable medium” may be used generally to refer to media such as, for example, the memory 603, the storage devices 604, the removable storage unit 607, or signal(s) on the channel 610. These and other forms of computer-readable media may be involved in providing one or more sequences of one or more instructions to the processor 601 for execution. Such instructions, generally referred to as “computer program code” (which may be grouped in the form of computer programs or other groupings), when executed, enable the computing system 600 to perform features or functions of embodiments of the present invention.

In an embodiment where the elements are implemented using software, the software may be stored in a computer-readable medium and loaded into the computing system 600 using, for example, the removable storage unit 607, the media drive 605 or the communications interface 609. The control logic (in this example, software instructions or computer program code), when executed by the processor 601, causes the processor 601 to perform the functions of the invention as described herein.

Thus, the disclosed method and system try to overcome the technical problem of generating near real-time responses to user queries. The method and system provide automated customer support. The virtual agent system handles routine inquiries and provides instant responses to common questions. The virtual agent system resolves issues related to products, services, billing, and technical support.

The method and system provide an Interactive Voice Response (IVR). The virtual agent system acts as an intelligent IVR system, guiding customers through options and resolving queries without human intervention. The virtual agent system reduces wait times and improves the customer experience.

The method and system provide personalized customer interaction. The virtual agent system leverages user-specific data to provide personalized responses and recommendations. The virtual agent system enhances customer engagement by remembering past interactions and preferences.

The method and system provide complex query resolution. The virtual agent system manages and resolves complex queries by understanding the context and retrieving relevant information from the knowledge graph. The virtual agent system escalates unresolved or highly complex issues to human agents with all relevant context provided.

The method and system provide feedback collection and analysis. The virtual agent system collects customer feedback during and after interactions. The virtual agent system analyzes feedback to identify areas for improvement and optimize the knowledge base.

The method and system may be useful for training and onboarding. The virtual agent system serves as a training tool for new call center agents by providing them with access to a comprehensive and well-organized knowledge base. The virtual agent system helps in onboarding by familiarizing new agents with common queries and resolutions.

The method and system provide Proactive Customer Service. The virtual agent system uses predictive analytics to identify potential issues before they become significant problems. The virtual agent system notifies customers proactively about issues or changes that may affect them.

As will be appreciated by those skilled in the art, the techniques described in the various embodiments discussed above are not routine, or conventional, or well understood in the art.

The techniques provide an increased efficiency and cost savings. The virtual agent system reduces the need for human agents to handle routine inquiries, leading to significant cost savings. The virtual agent system enhances efficiency of contact centers by handling a large volume of queries simultaneously.

The techniques further provide improved customer satisfaction. The virtual agent system provides instant and accurate responses, reducing wait times and improving the overall customer experience. The virtual agent system maintains a consistent level of service quality across all interactions.

The techniques further provide enhanced knowledge management. The virtual agent system organizes information in a structured manner, making it easier to retrieve and update knowledge. The virtual agent system ensures that the most current and relevant information is always available through the customized knowledge graph.

The techniques further provide continuous learning and adaptation. The virtual agent system learns from every interaction, continuously improving its performance and accuracy. The virtual agent system incorporates user feedback to refine responses and update the knowledge base.

The techniques further provide scalability. The virtual agent system can easily scale to handle increased call volumes without a corresponding increase in operational costs. The virtual agent system adapts to growing business needs and can be customized for different industries.

The techniques further provide contextual and accurate responses. The virtual agent system provides more relevant and accurate responses by understanding the context of queries. The virtual agent system ensures continuity in conversations by maintaining context across multiple interactions.

The techniques further provide advanced analytics and insights. The virtual agent system offers detailed analytics on customer interactions, helping businesses identify trends and areas for improvement. The virtual agent system provides insights into common customer issues, enabling proactive management and resolution.

The techniques further provide enhanced agent productivity. The virtual agent system frees up human agents to focus on more complex and high-value tasks. The virtual agent system reduces the cognitive load on agents by providing them with comprehensive and organized information.

The techniques further provide interoperability and integration. The virtual agent system facilitates integration with other enterprise systems and platforms, enhancing overall business processes. The virtual agent system ensures that information is consistent and up-to-date across different systems.

The techniques further provide customization and flexibility. The virtual agent system allows businesses to customize the system to meet their specific needs and industry requirements. The virtual agent system supports multiple languages and regions, catering to a diverse customer base.

By incorporating an ontology-backed knowledge graph, the proposed virtual agent system not only automates and streamlines call center operations but also enhances the overall quality of customer support, leading to higher satisfaction and better business outcomes.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for generating near real-time responses to user queries. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for generating near real-time responses to user queries, the method comprising:
initiating, by a processor, a user session associated with a user account;
generating, by the processor via a Large Language Model (LLM), a set of predicted queries and a corresponding set of predicted responses, based on at least one of historical data or a real-time input user query associated with the user account, using a customized knowledge graph, and wherein the customized knowledge graph is based on domain-specific data and enterprise-specific data;
creating, by the processor, a set of predicted query embeddings from each of the set of predicted queries and a set of predicted response embeddings from each of the set of predicted responses, using an embedding model;
comparing, by the processor, a subsequently received real-time input user query with each of the set of predicted queries through a similarity analysis, wherein the comparing comprises:
creating a set of input user query embeddings from the real-time input user query using the embedding model;
calculating a semantic similarity score between the set of input user query embeddings and the set of predicted user query embeddings of each the set of predicted user queries; and
comparing the semantic similarity score with a predefined threshold semantic similarity score; and
upon successful comparison of at least one of the set of predicted queries, generating in near real-time, by the processor via the LLM, a response to the real-time input user query based on the set of predicted response embeddings of each of at least one of the set of predicted responses corresponding to each of the at least one of the set of predicted queries using the customized knowledge graph.

2. The method of claim 1, further comprising:
receiving the real-time input user query in a format selected from a text format or an audio format; and
when the format is the audio format, transforming the format of the real-time input user query into the text format using a speech-to-text conversion technique prior to comparing with each of the set of predicted queries.

3. The method of claim 1, wherein generating the set of predicted queries comprises predicting, via the LLM, the set of predicted queries using the historical data associated with the user account prior to receiving the real-time input user query, wherein each of the set of predicted queries is a complete query.

4. The method of claim 1, wherein generating the set of predicted queries comprises:
predicting in real-time, via the LLM, a set of second portions of the real-time input user query based on a first portion of the real-time input user query received in real-time, wherein each of the set of second portions corresponds to a predicted remaining portion of the first portion; and
combining, via the LLM, the first portion with each of the predicted set of second portions to obtain the set of predicted queries.

5. The method of claim 1, further comprising:
storing the set of predicted query embeddings and the set of predicted response embeddings in a vector database; and
retrieving the set of predicted query embeddings from the vector database upon receiving the real-time input user query for the comparison.

6. The method of claim 5, wherein generating in near real-time a response to the real-time input user query comprises:
for each successfully compared predicted query of the at least one of the set of predicted queries,
retrieving the set of predicted response embeddings of a predicted response corresponding to the successfully compared predicted query; and
providing a response generation prompt to the LLM, wherein the response generation prompt comprises the real-time input user query and the set of predicted response embeddings of each of the at least one of the set of predicted responses.

7. The method of claim 1, further comprising, upon unsuccessful comparison of each of the set of predicted queries, generating, via the LLM, a response to the real-time input user query using the customized knowledge graph.

8. The method of claim 1, further comprising transforming a format of the response to the real-time input user query to an audio format using a text-to-speech conversion algorithm to generate an audio output response to the real-time input user query.

9. The method of claim 1, further comprising determining a context and a user intent based on the real-time input user query and the historical data using a Natural Language Processing (NLP) model.

10. A system for generating near real-time responses to user queries, the system comprising:
a processor; and
a memory communicatively coupled to the processor, wherein the memory stores processor instructions, which when executed by the processor, cause the processor to:
initiate a user session associated with a user account;
generate, via an LLM, a set of predicted queries and a corresponding set of predicted responses, based on at least one of historical data or a real-time input user query associated with the user account, using a customized knowledge graph, and wherein the customized knowledge graph is based on domain-specific data and enterprise-specific data;
create a set of predicted query embeddings from each of the set of predicted queries and a set of predicted response embeddings from each of the set of predicted responses, using an embedding model;
compare a subsequently received real-time input user query with each of the set of predicted queries through a similarity analysis, wherein the comparing comprises:
create a set of input user query embeddings from the real-time input user query using the embedding model;
calculate a semantic similarity score between the set of input user query embeddings and the set of predicted user query embeddings of each the set of predicted user queries; and
compare the semantic similarity score with a predefined threshold semantic similarity score; and
upon successful comparison of at least one of the set of predicted queries, generate in near real-time, by the processor via the LLM, a response to the real-time input user query based on the set of predicted response embeddings of each of at least one of the set of predicted responses corresponding to each of the at least one of the set of predicted queries using the customized knowledge graph.

11. The system of claim 10, wherein the processor instructions, on execution, further cause the processor to:
receive the real-time input user query in a format selected from a text format or an audio format; and
when the format is the audio format, transform the format of the real-time input user query into the text format using a speech-to-text conversion technique prior to comparing with each of the set of predicted queries.

12. The system of claim 10, wherein to generate the set of predicted queries, the processor instructions, on execution, cause the processor to predict, via the LLM, the set of predicted queries using the historical data associated with the user account prior to receiving the real-time input user query, wherein each of the set of predicted queries is a complete query.

13. The system of claim 10, wherein to generate the set of predicted queries, the processor instructions, on execution, cause the processor to:
predict in real-time, via the LLM, a set of second portions of the real-time input user query based on a first portion of the real-time input user query received in real-time, wherein each of the set of second portions corresponds to a predicted remaining portion of the first portion; and
combine, via the LLM, the first portion with each of the predicted set of second portions to obtain the set of predicted queries.

14. The system of claim 10, wherein the processor instructions, on execution, further cause the processor to:
store the set of predicted query embeddings and the set of predicted response embeddings in a vector database; and
retrieve the set of predicted query embeddings from the vector database upon receiving the real-time input user query for the comparison.

15. The system of claim 14, wherein generating in near real-time a response to the real-time input user query comprises:
for each successfully compared predicted query of the at least one of the set of predicted queries,
retrieve the set of predicted response embeddings of a predicted response corresponding to the successfully compared predicted query; and
provide a response generation prompt to the LLM, wherein the response generation prompt comprises the real-time input user query and the set of predicted response embeddings of each of the at least one of the set of predicted responses.

16. The system of claim 10, wherein the processor instructions, on execution, further cause the processor to, upon unsuccessful comparison of each of the set of predicted queries, generate, via the LLM, a response to the real-time input user query using the customized knowledge graph.

17. The system of claim 10, wherein the processor instructions, on execution, further cause the processor to transform a format of the response to the real-time input user query to an audio format using a text-to-speech conversion algorithm to generate an audio output response to the real-time input user query.

18. The system of claim 10, wherein the processor instructions, on execution, further cause the processor to determine a context and a user intent based on the real-time input user query and the historical data using an NLP model.

19. A non-transitory computer-readable medium storing computer-executable instructions for generating near real-time responses to user queries, the computer-executable instructions configured for:
initiating a user session associated with a user account;
generating, via an LLM, a set of predicted queries and a corresponding set of predicted responses, based on at least one of historical data or a real-time input user query associated with the user account, using a customized knowledge graph, and wherein the customized knowledge graph is based on domain-specific data and enterprise-specific data;
creating a set of predicted query embeddings from each of the set of predicted queries and a set of predicted response embeddings from each of the set of predicted responses, using an embedding model;
comparing a subsequently received real-time input user query with each of the set of predicted queries through a similarity analysis, wherein the comparing comprises:
creating a set of input user query embeddings from the real-time input user query using the embedding model;
calculating a semantic similarity score between the set of input user query embeddings and the set of predicted user query embeddings of each the set of predicted user queries; and
comparing the semantic similarity score with a predefined threshold semantic similarity score; and
upon successful comparison of at least one of the set of predicted queries, generating in near real-time, via the LLM, a response to the real-time input user query based on the set of predicted response embeddings of each of at least one of the set of predicted responses corresponding to each of the at least one of the set of predicted queries using the customized knowledge graph.

20. The non-transitory computer-readable medium of claim 19, wherein generating the set of predicted queries comprises:
predicting in real-time, via the LLM, a set of second portions of the real-time input user query based on a first portion of the real-time input user query received in real-time, wherein each of the set of second portions corresponds to a predicted remaining portion of the first portion; and
combining, via the LLM, the first portion with each of the predicted set of second portions to obtain the set of predicted queries.
